(19) United States
(12) Patent Application Publication
(10) Pub. No.: US 2026/0314771 A1
(43) Pub. Date: Oct. 15, 2026

(54) CONVERTIBLE LUGGAGE

(71) Applicant: Tristan Palmer-Morgan, Ogmore-by-Sea (GB)

(72) Inventor: Tristan Palmer-Morgan, Ogmore-by-Sea (GB)

(21) Appl. No.: 19/476,429

(22) PCT Filed: Apr. 16, 2024
(86) PCT No.: PCT/GB2024/050990

§ 371 Date: Oct. 17, 2025

(30) Foreign Application Priority Data
Apr. 19, 2023 (GB) 2305728.4

(51) Int. Cl. A45C 5/03; A45C 7/00; A45C 9/00; A45C 13/26; A45C 13/38; A45F 3/04; B62B 7/12; B62B 19/04

(52) U.S. Cl. CPC A45C 5/03; A45C 7/0045; A45C 9/00; A45C 13/385; A45F 3/04; B62B 7/12; B62B 19/04; A45C 2005/035; A45C 2009/002; A45C 2009/005; A45C 2013/265; A45C 2013/267; B62B 2206/006

(57) ABSTRACT

The invention concerns an item of luggage, such as a suitcase, that can be converted into at least one other item, such as a trolley, rucksack or pushchair, as a result of the adaptable nature of its construction. The luggage is characterised in that it is provided with at least one pair of wheels and each wheel is mounted on an extendable and rotatable rod whereby each wheel can be positioned away from said luggage and rotated through 180° to be turned outward with respect to the midline of said luggage.

### FIELD OF THE INVENTION

The invention concerns an item of luggage, such as a suitcase, that can be converted into at least one other item, such as a trolley, rucksack or pushchair, as a result of the adaptable nature of its construction. The luggage is characterized in that it is provided with at least one pair of wheels, and each wheel is mounted on an extendable and rotatable rod whereby each wheel can be positioned away from said luggage and rotated through 180° to be turned outward with respect to the midline of said luggage.

### BACKGROUND OF THE INVENTION

This invention solves the issue of transporting goods, particularly but not exclusively, when travelling and after one has reached a destination.

Items of luggage tend to be bulky, and their use solely during travel is a potential waste of materials and money. It would be far more desirable to ensure such items can serve more than one purpose and so, not only find use during travel, but also during the everyday. For example, it would be highly desirable if items of luggage could be converted into other useful carriers whereby sports gear, shopping, picnics, beach gear and even children can be moved/carried around, it is especially desirable for a single item to be able to serve multiple purposes, for example, during a vacation or holiday. This would mean an item of luggage, after arriving at one's destination, had further usage, thus assisting in the carrying of all the goods associated with children, heading down to the beach, transporting water gear onto a boat/yacht, or even heading to the shops.

With this in mind, we have constructed a suitcase that converts into a transportation trolly, rucksack or stroller/pushchair/pram and so can be used for more than one function other than the primary purpose of luggage.

### STATEMENTS OF INVENTION

According to a first aspect of the invention there is provided a suitcase comprising a frame onto which, or about which, a carrier for possessions is removably mounted, wherein associated with said frame is a handle and at least a pair of wheels on which said suitcase is maneuvered; characterised in that each wheel is mounted on an extendable and rotatable rod whereby each wheel can be positioned away from said suitcase and rotated through 180° to be turned outward with respect to the midline of said suitcase.

The invention therefore enables the wheels of the case to be extended and flipped over to offer a broader, more stable, load-bearing wheelbase, and, advantageously, with greater ground clearance. This feature facilitates the conversion of the suitcase into a trolley or stroller and so greatly assists in its multi-functional use.

In a preferred embodiment of the invention each rod, on which said wheel is mounted, is attached to said frame and/or said carrier so that it project outwards at an angle to the vertical, ideally at an angel between 30°-60° to the vertical, including all 1° divisions in between, most ideally 40°-50° to the vertical, including all 1° divisions in between, and yet most preferably substantially at or about 45° to the vertical.

In a preferred embodiment of the invention, said frame and/or carrier is/are fashioned to provide at least one recess into which at least one wheel is at least partially located.

As will be appreciated, preferably, the frame of the case is made from a relatively rigid material of the following kind and/or having the following properties: Nylon12, polypropylene and or Carbon fibre, Acrylonitrile butadiene styrene (ABS), Resin, not exceeding dimensions: 480 mm×290 mm×670 mm.

In contrast, the carrier is made from a more flexible material that is more suitable to acting as a rucksack, such as Canvas, Nylon, Rip-Stop Nylon, Ballistic Nylon, Kodra Nylon, 840D Nylon TPU, 1000D Ballistic Nylon, Leather, Denim, PVC, Polyester, Polypropylene, Cordura or the like, and so is equipped with shoulder straps, handles and pockets etc. 210D honeycomb nylon, not exceeding dimensions: 480 mm×290 mm×670 mm.

In a more preferred embodiment of the invention said frame is fashioned into the form of a trolley and the carrier is fashioned to sit therein or there against. Ideally the two parts are complementary and so suited for use together. In this embodiment of the invention, ideally, the suitcase has a handle that is adapted for angular positioning, typically by the use of a hinge, whereby the handle can be moved from a first, typically but not exclusively, vertical position (having regard to the upright nature of the case when rolling on its wheels) to a second angled position (also having regard to the upright nature of the case when rolling on its wheels) whereby the trolley can comfortably be pulled/pushed along.

In yet a further preferred embodiment, said frame, when in the form of a trolley or otherwise, is provided with a removable or hinged seat whereby, in use, the seat can be attached to the trolley for a child to sit thereupon or the seat can be swung into a usable position, and ideally locked in this position, for a child to sit thereupon.

In a preferred embodiment, said removable seat is in the form of a hammock with connectors for attaching same to said frame or trolley. Additionally, or alternatively, said hinged seat is fashioned for storage within or against said frame or trolley when not in use.

In any case, said seat is optionally adapted for comfort by the provision of padding, a cushion or the like.

In a further preferred embodiment of the invention at least one, and ideally both, of said pair of wheels comprises two separable wheels, typically fashioned for mating or nesting there together and mounting on a single axle. In this embodiment, the suitcase is, essentially equipped with at least one spare wheel and more usually a spare pair of wheels. This is advantageous, as the separable wheels can be parted and mounted on a further part of the frame, or on an attachment for said frame, in order to provide a carrier that is stably mounted at each of four corners, ideally the four corners of the case, frame or trolley. This provides for extra stability and ease of use. It will be appreciated this arrangement is most preferred where the case is to be converted into a stroller or child-carrier.

In yet a further embodiment of the invention, said suitcase is provided with a set of ski runners adapted to be clipped over or attached to the existing wheels of the suitcase or, optionally, substituted therefor, whereby when using the case on snow and/or ice, the ski runners can be used to ensure smooth motion. Typically, the ski runners are adapted in a conventional fashion to be used with the case and so may include conventional ski clips that enables the ski runners to be attached to the existing wheels or to the wheel fixings which become exposed or available once the existing wheels are removed. In this way, at least, the suitcase can be adapted to move over snow or ice. Moreover, the ski runners may be used with the case before or after it has been adapted for use as a trolley, stroller or pushchair.

In a further preferred embodiment of the invention, said handle is adapted for extension and/or retraction and is, ideally, hinged, whereby the angle of same can be adjusted.

In yet a further preferred embodiment of the invention said frame and/or carrier is provided with at least one auxiliary rod on which an auxiliary wheel can be mounted, ideally this rod is attached to said frame and/or carrier so that when not in use it sits in a retracted position or in a position that, at least partially, is not visible. Preferably, this auxiliary rod is hinged or slidably mounted, or mounted in a conventional manner, so that is can be extended to project beyond said suitcase. Most ideally, it comprises a hinged arrangement whereby it can be flipped in to, our out of, position. Most preferably it is fashioned to mate with the suitcase so that when not in use it rests unobtrusively against same, but when in use it projects in an arc fashion and a wheel can be mounted on its ground engaging end. Yet more preferably said auxiliary rod is attached to said suitcase on a side opposite to that of said extendable and rotatable rod(s). Yet more preferably still, the ground engaging end of said auxiliary rod has a width commensurate with the width of the frame to which it is attached or to which it is nearest.

According to a second aspect of the invention, there is provided a suitcase as afore described that is adapted for conversion into a trolley.

According to a third aspect of the invention, there is provided a suitcase as afore described that is adapted for conversion into a stroller or pushchair.

According to a fourth aspect of the invention, there is provided a suitcase as afore described that is adapted for conversion into a rucksack.

Preferred features of each aspect of the invention may be as described in connection with any of the other aspects.

Throughout the description and claims of this specification, the words “comprise” and “contain” and variations of the words, for example “comprising” and “comprises”, mean “including but not limited to” and do not exclude other moieties, additives, components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

All references, including any patent or patent application, cited in this specification are hereby incorporated by reference. No admission is made that any reference constitutes prior art. Further, no admission is made that any of the prior art constitutes part of the common general knowledge in the art.

Other features of the present invention will become apparent from the following examples. Generally speaking, the invention extends to any novel one, or any novel combination, of the features disclosed in this specification (including the accompanying claims and drawings). Thus, features, integers, characteristics, compounds or chemical moieties described in conjunction with a particular aspect, embodiment or example of the invention are to be understood to be applicable to any other aspect, embodiment or example described herein, unless incompatible therewith.

Moreover, unless stated otherwise, any feature disclosed herein may be replaced by an alternative feature serving the same or a similar purpose.

The Invention will now be described by way of example only with reference to the Examples below and to the following Figures wherein:

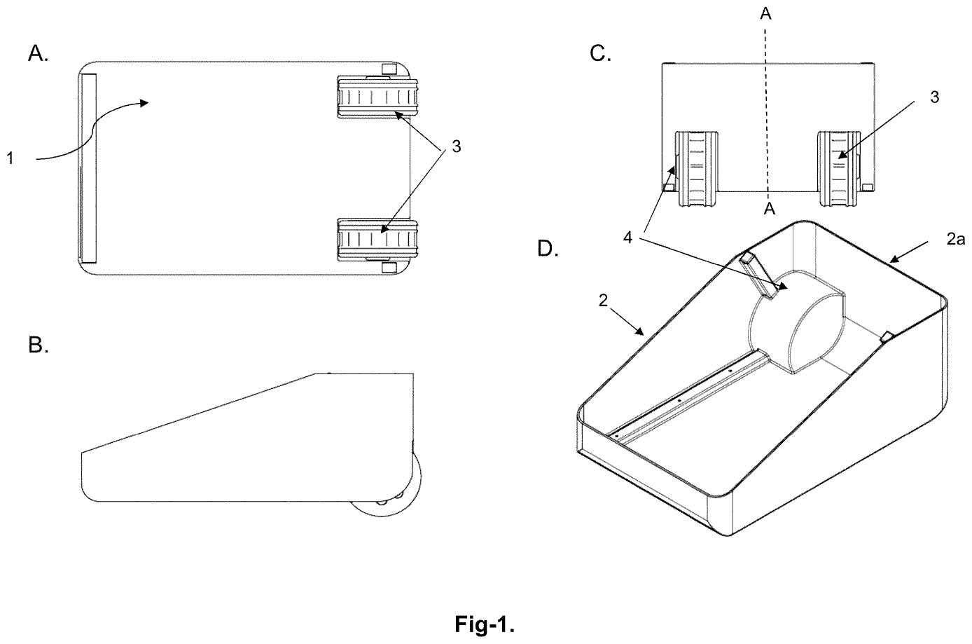

FIG. 1. Shows a part of a suitcase frame according to the invention. A is a plan view, B is a side view, C is a part rear view, and D is a perspective view of said frame.

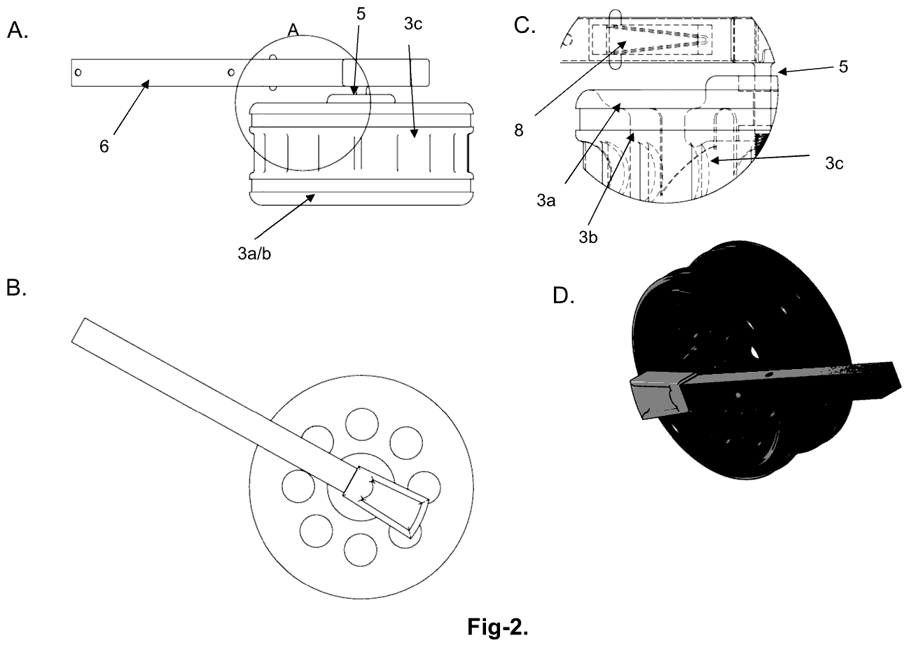

FIG. 2. Shows a wheel for use with said frame of FIG. 1 where A is plan view, B is a side view, C is a partial exploded side view of the region shown in A, and D is a perspective view of said wheel.

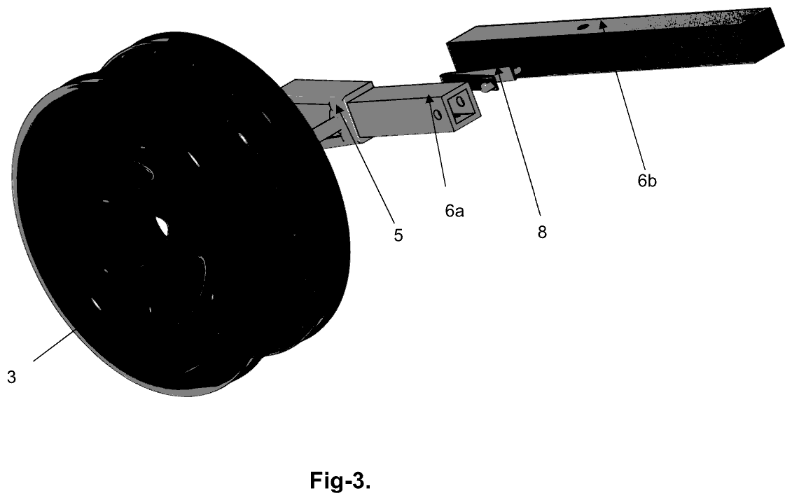

FIG. 3. Shows an exploded perspective view of a wheel that can be used in the working of the invention.

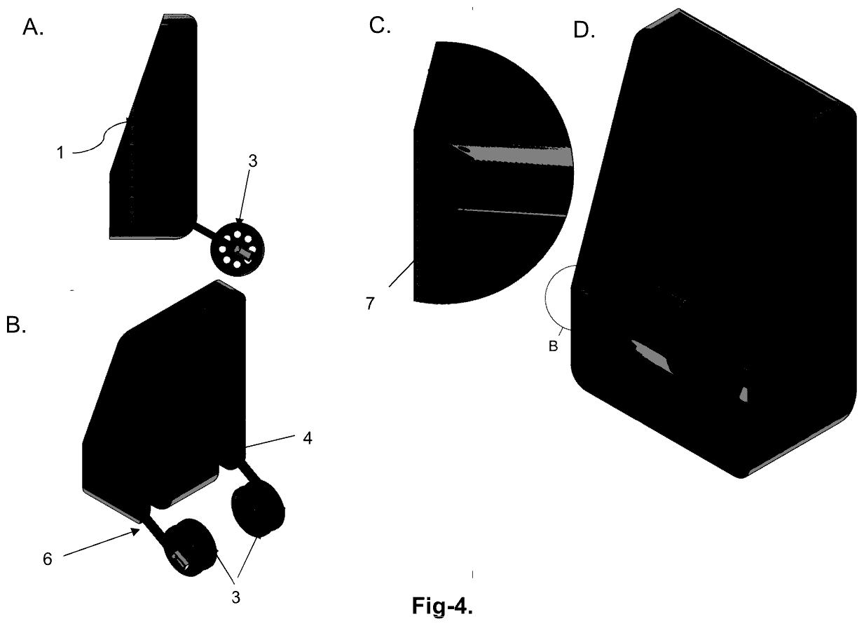

FIG. 4. Shows a suitcase with wheels attached. A is a partial side view of the frame with the wheels attached, B is a rear perspective view of the frame when the wheels are attached, C is a partial perspective view of the frame showing where the extendable rod for a wheel is attached to the frame, and D is a perspective view of the inside of the frame.

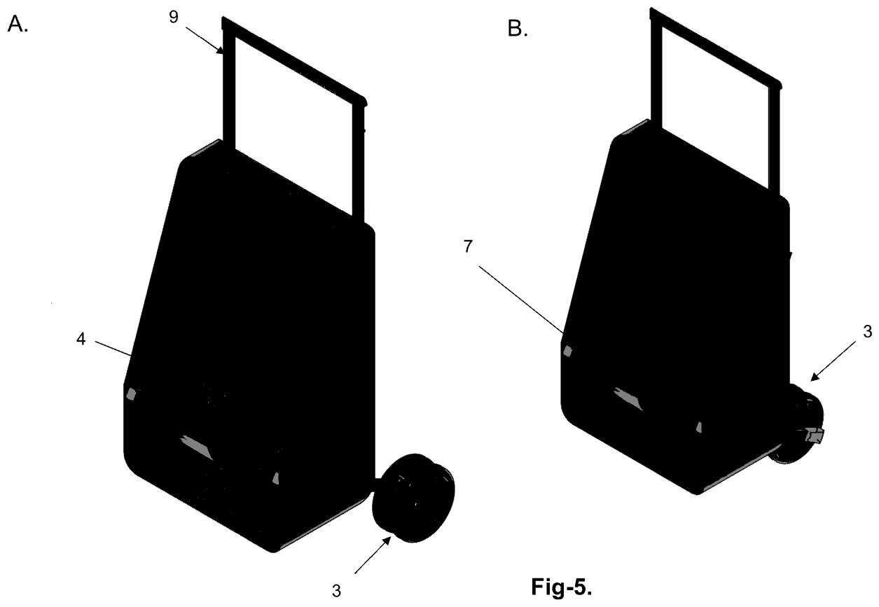

FIG. 5. Shows a frame and with wheels attached in accordance with one embodiment of the invention. A shows the wheels extended and B shows the wheels retracted.

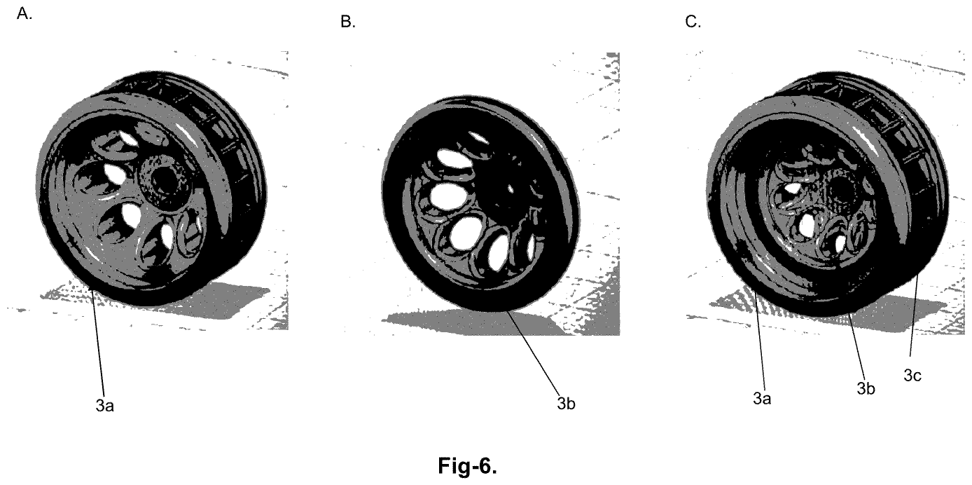

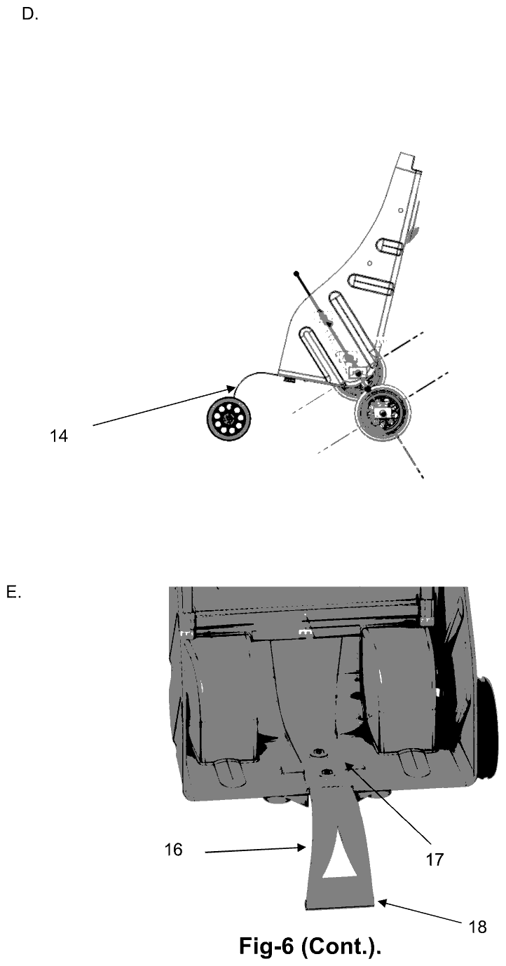

FIG. 6. Shows a perspective view of a pair of separable wheels for use in the invention.

FIG. 7. Shows a side view of a frame and carrier according to the invention.

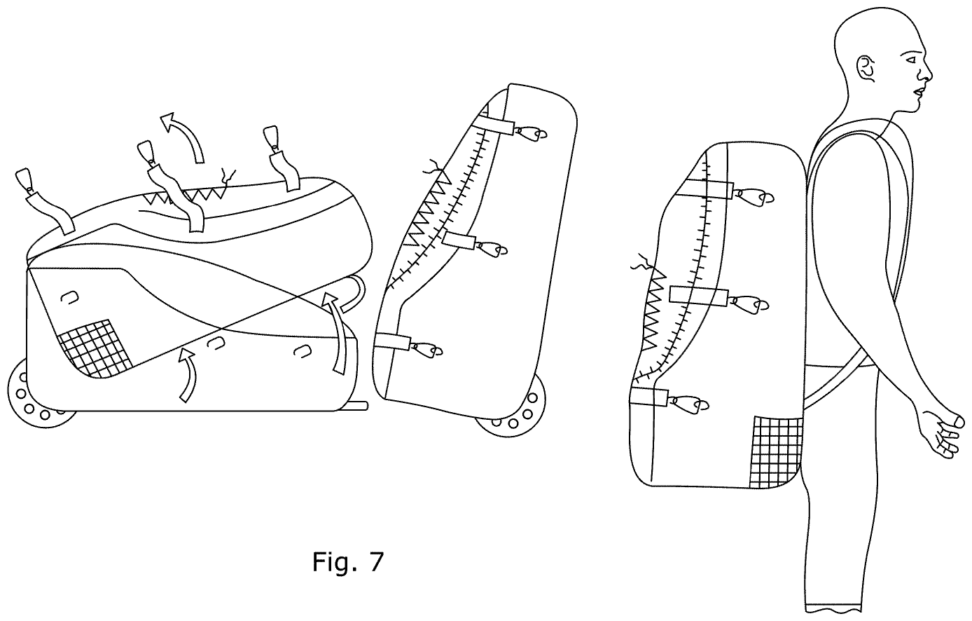

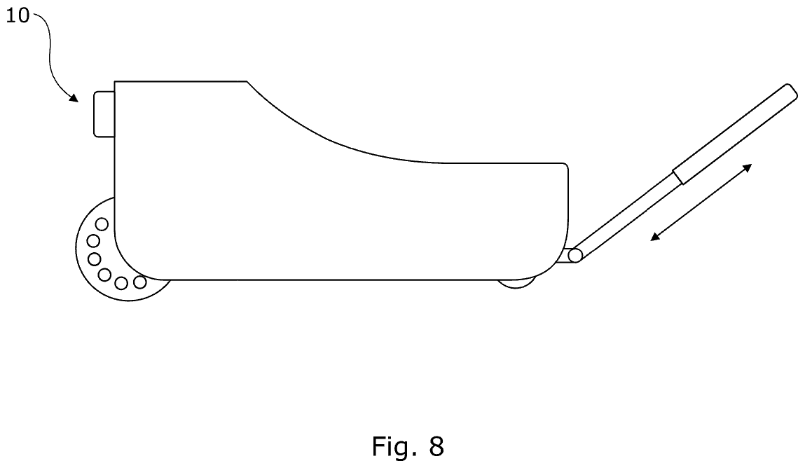

FIG. 8. Shows a side of the frame of the invention when used as a trolley.

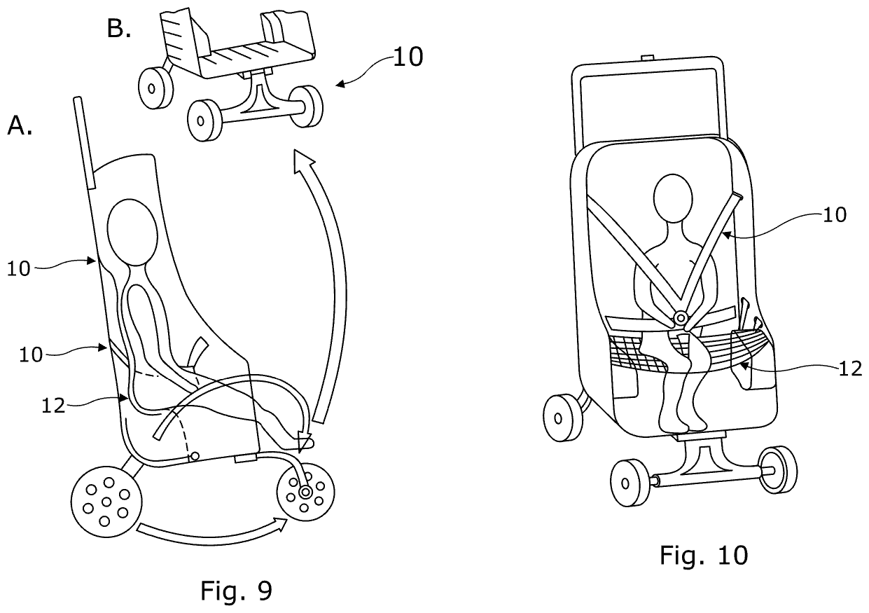

FIG. 9. Shows a side elevation of the frame of the invention when used as a stroller or pushchair A, and B shows a partial front elevation of the same stroller or pushchair.

FIG. 10. Shows an alternative embodiment of a front elevation of a frame when used as a stroller or pushchair.

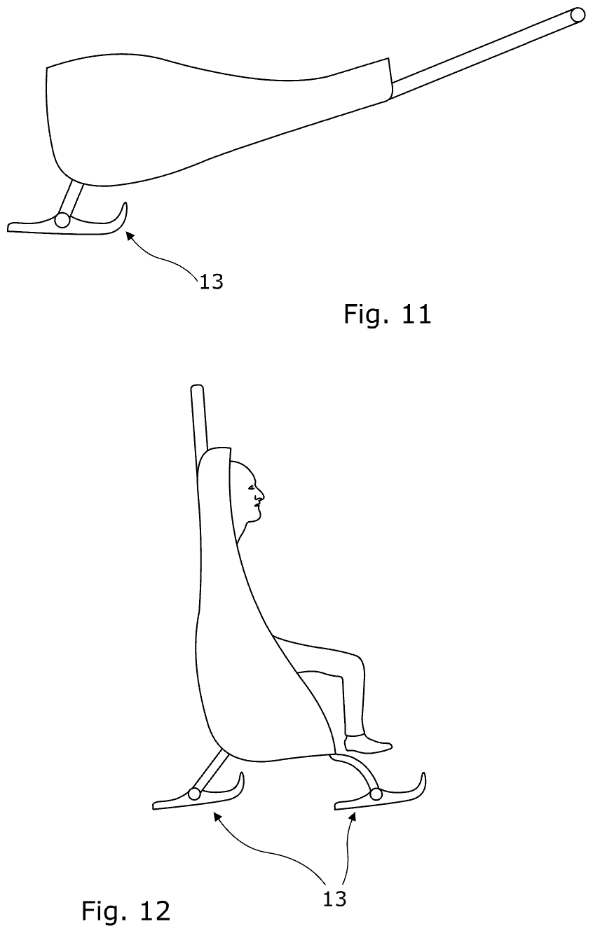

FIG. 11. Shows a side view of a frame of the invention when used as a trolley and equipped with ski runners for use on snow and ice.

FIG. 12. Shows a side view of a frame of the invention when used as a pushchair and equipped with ski runners for use on snow and ice.

Referring now to the figures and, firstly, to FIG. 1, there is shown an embodiment of a frame (1) according to the invention. As can be seen in FIG. 1A, frame (1) is generally rectangular in plan view but having sides (2) that are deeper towards the base FIG. 1B where the frame (1) is fashioned to at least, partially, accommodate a pair of wheels (3). The wheels (3) are mounted symmetrically along the base of the frame and so equidistant from a longitudinal midline A-A thereof FIG. 1C. Recess (4) in the frame FIGS. 1C & 1D, at least partially encases a wheel. A pair of such recesses (not shown in 1D) is provided and so each wheel is encased by a single recess.

Frame 1 is made of a relatively rigid material. The material has to be rigid enough to support the contents of the case and shield them from damage during transport and also strong enough to act as a trolley or pushchair when the suitcase is converted for a different use. Suitable materials include: polypropylene and or Carbon fibre and or ABS.

Referring now to FIG. 2, there is shown a wheel for use with the frame of FIG. 1. Wheel (3), in this embodiment, is in the form of a pair of ground-engaging wheels (3a & 3b) spaced and held together by sprockets (3c). Wheel (3) is mounted on an axle (5) connected to a rod (6). Rod (6), which may, or may not be telescopic, is mounted on frame (1) so as to be extendable therefrom. This is best shown in FIG. 4C, where frame 1 is fashioned to provide a compartment (7) in which rod (6) is stored until it is extended.

Additionally, rod (6) is mounted on frame 1 so that at least a part thereof is adapted to be rotated, that is the part making contact with wheel (3).

FIG. 3 shows in greater detail an exploded perspective view of a wheel (3) for use with the frame (1) of the invention. It can be seen that wheel (3) is mounted on axle (5) which is, in turn, attached to rod (6). In this embodiment, rod (6) is telescopic and so comprises parts (6a) and (6b). One of parts (6a) and (6b) has a tensioned (spring-loaded) locking pin (8) whereby rod (6) can be securely locked in place before or after extension or retraction. However, other means may be used to lock the extended and/or rotated wheel in place following manipulation such as by the use of interlocking rotatable cylinders, pin & barrel, spring loaded catches, and slotting concepts.

FIG. 4 shows, in perspective view a frame (1) and its associated wheels (3). In FIGS. 4A and B, each rod (6) associated with each of two wheels (3), has been extended and so moved into a position away from the frame (1). Notably, wheels (3) are still aligned with recesses (4). This manoeuvre represents a first modification of the suitcase. Rods (6) carrying wheels (3) are then rotated through 180° thus, effectively, flipping the wheels (3) over and outwards, thus increasing the distance between same and so increasing the wheelbase of the frame, providing for greater stability. This manoeuvre represents a second modification of the suitcase.

FIG. 5A shows wheels (3) when flipped over and so positioned to the side of frame (1). FIG. 5B shows wheels (3) when prior to being flipped over and so positioned to the side of frame (1).

Additionally, it can be seen from FIG. 4A and FIG. 5 that the wheels are attached to said frame so that they project outwards at an angle to the vertical, in this embodiment at an angel between 50°-55° to the vertical, although an angle substantially at or about 45° to the vertical is preferred.

Also shown in FIG. 5, is handle (9), attached to the upper part of frame (1) and adapted for extension or retraction. Although not shown, handle (9) can be hingedly attached to frame (1) so that it can be used at an angle with respect to the upright nature of the suitcase.

In FIG. 6 there is shown in greater detail the separable nature of wheels (3). In this embodiment, the wheels are provided in pairs and fashioned to be used in nested fashion and adapted for mounting on a single axle whereby they can be used as a single double wheel or the two wheels can be separated and each one used in a different position on said frame. Where the wheels are to be separated, the nested nature is reversible, and so any means, such as at least one sprocket (3c) for holding the wheels together can be removed or released.

FIGS. 6D and 6E show yet another embodiment of the invention, which is equipped with at least one auxiliary rod (14) on which an auxiliary wheel (15) can be mounted. Ideally this rod is attached to said frame, but in some embodiments it may be attached to the carrier, so that when not in use it sits in a retracted position or in a position that, at least partially, is not visible. This arrangement is shown in FIG. 6C. Auxiliary rod (14) is fashioned to mate with the suitcase so that when not in use it rests unobtrusively against same. In this embodiment, auxiliary rod (14) is arc shaped (16) and of a curvature that matches the side of the suitcase. Auxiliary rod (14) is hinged (17), or slidably mounted or mounted in a conventional manner, so that is can be extended to project beyond said suitcase. A hinged arrangement is preferred whereby it can be flipped in to, our out of, position. When in use, it projects in an arc fashion and it is adapted, by the inclusion of an axle accommodating member (19) on its ground engaging end (18) for the attachment of a wheel, ideally an inner wheel from the nested wheel arrangement shown in FIGS. 6A-C. As can be seen in FIG. 6B, auxiliary rod (14) is attached to said suitcase on a side opposite to that of said extendable and rotatable rod(s).

FIG. 7 is a side view of a frame and carrier according to the invention where the carrier is in the form of a rucksack that can be detached from the frame so that it has use as a part of a suitcase when mounted on the frame and use as a rucksack when separated therefrom.

FIG. 8 is a side view of the frame of the invention when used as a trolley. In this embodiment, the carrier has been removed, and a hinged telescopic handle is used so that the handle can be hinged upwards and extended to more ergonomically steer or pull said trolley. It can be further seen that, in this embodiment, the frame is provided with a resting block (10) located on an edge of said frame (1) opposite the wheel, so that, when stationary, the frame can rest against same.

FIG. 9A shows a side elevation of the frame of the invention when used as a stroller or pushchair A. It can be seen that the frame has a wheel (3) positioned at each one of four corners. The rear wheels are provided on extendable and rotatable rods (6) whereas the two front wheels are provided on an extended auxiliary rod (14) whose ground engaging end has a width commensurate with the width of the frame to which it is attached or to which it is nearest. Moreover, the internal surface of the frame is provided with connectors to which straps (11) and a hammock (12) are attached. In this way, the frame is adapted to accommodate a seated child. In FIG. 10, there is shown a front view of the stroller or pushchair, lower part of the frame which is provided by the auxiliary rod (14) fashioned in the form of an arched T-bar which, in this embodiment, clip connects with the frame and has an axle on which a pair of wheels can be mounted. Ideally, the wheels are those nested wheels described in FIG. 6 when separated. It can be seen that straps (11) are attached to the frame, in conventional fashion, for ensuring a child is secured within the stroller or pushchair. Further, a hammock (12) is also provided for a child to sit upon.

Referring now to FIG. 11, there is shown a side view of a frame when used as a trolley and it can be seen it has been equipped with ski runners (13) for use on snow and ice. The ski runners are of a conventional nature and so include conventional ski clips that enables the ski runners to be attached to the existing wheels or to the wheel fixings which become exposed or available once the existing wheels are removed.

FIG. 12 also shows a side view of a frame but in this instance the frame is being used as a pushchair. Again, it can be seen that the frame has been equipped with ski runners (13) for use on snow and ice. These ski runners are attached to the wheels or the wheel fixings, typically but not exclusively, after the wheels have been removed.

The ski runners may be used with the suitcase before or after it has been adapted for use as a trolley, stroller or pushchair. In this way, at least, the suitcase can be adapted to move over snow or ice.

Thus, the invention relates to a suitcase suitably adapted so that it can be converted into another item of carriage.

1. A suitcase comprising a frame onto which, or about which, a carrier for possessions is removably mounted, wherein associated with said frame is a handle and at least a pair of wheels on which said suitcase is maneuvered; characterised in that each wheel is mounted on an extendable and rotatable rod whereby each wheel can be positioned away from said suitcase and rotated through 180° to be turned outward with respect to a midline of said suitcase.

2. The suitcase according to claim 1 wherein each rod is attached to said frame and/or said carrier so that it projects outwards at an angle to the vertical selected from the group comprising: between 30°-60° to the vertical, including all 1° divisions in between; between 40°-50° to the vertical, including all 1° divisions in between; and substantially at or about 45° to the vertical.

3. The suitcase according to claim 1 wherein said frame and/or carrier is/are fashioned to provide at least one recess into which at least one wheel of the at least a pair of wheels is at least partially located.

4. The suitcase according to claim 1 wherein said frame is fashioned into the form of a trolley.

5. The suitcase according to claim 4 wherein the carrier is fashioned to sit in or against said frame.

6. The suitcase according to claim 4 wherein the frame and carrier are complementary and so adapted for use together.

7. The suitcase according to claim 1 wherein the suitcase handle is adapted for angular positioning.

8. The suitcase according to claim 7 wherein the handle is hinged to or on said frame, whereby the handle can be moved from a first to a second angled position.

9. The suitcase according to claim 1 wherein said frame is provided with a removable or hinged seat whereby, in use, the seat can be attached to the frame to serve as a seat or the seat can be swung into a usable position to serve as a seat.

10. The suitcase according to claim 9 wherein said removable seat is in the form of a hammock with connectors for attaching same to said frame.

11. The suitcase according to claim 9 wherein said hinged seat is adapted for storage within or against said frame when not in use.

12. The suitcase according to claim 9 wherein said seat is adapted for comfort by the provision of padding, a cushion or the like.

13. The suitcase according to claim 1 wherein at least one of said at least a pair of wheels comprises two separable wheels.

14. The suitcase according to claim 13 wherein said separable wheels are fashioned for mating or nesting together and for mounting on a single axle.

15. The suitcase according to claim 1 wherein said handle is adapted for extension and/or retraction.

16. The suitcase according to claim 1 wherein said frame and/or carrier is provided with at least one releasable or movable auxiliary rod on which an auxiliary wheel can be mounted whereby when not in use the auxiliary rod sits in a retracted position or in a position that, at least partially, is not visible.

17. The suitcase according to claim 16 wherein the auxiliary rod is fashioned to mate with the suitcase so that, when not in use, it rests unobtrusively against same, and, when in use, it projects in an arc fashion.

18. The suitcase according to claim 16 wherein the auxiliary rod is adapted so that a wheel can be mounted on its ground engaging end.

19. The suitcase according to claim 18 wherein the ground engaging end of said auxiliary rod has a width commensurate with the width of the frame to which it is attached or to which it is nearest.

20. The suitcase according to claim 16 wherein the auxiliary rod is attached to said suitcase on a side opposite to that of said extendable and rotatable rod(s).

21. The suitcase according to claim 1 wherein said suitcase comprises at least one pair of ski runners whereby the case can be adapted for motion over snow and/or ice.

22. The suitcase according to claim 1 wherein said suitcase is adapted for conversion into a trolley.

23. The suitcase according to claim 1 wherein said suitcase is adapted for conversion into a stroller or pushchair.

24. The suitcase according to any claim 1 wherein said suitcase is adapted for conversion into or providing a rucksack.
